(19) United States
(12) Patent Application Publication
(10) Pub. No.: US 2020/0375225 A1
(43) Pub. Date: Dec. 3, 2020

(54) GRANULE PREHEATING DEVICE AND A GRANULE PREHEATING METHOD THEREOF FOR PREHEATING BEFORE PROCESSING A GRANULAR FOOD MATERIAL WITH A FOOD PROCESSING MACHINE, AND A GRANULE TEMPERATURE ADJUSTMENT DEVICE AND A GRANULE TEMPERATURE ADJUSTMENT METHOD THEREOF FOR PREHEATING OR PRECOOLING BEFORE PROCESSING A GRANULAR FOOD MATERIAL WITH A FOOD PROCESSING MACHINE

(71) Applicant: SODICK CO., LTD., Kanagawa (JP)

(72) Inventors: Takeshi OKIYAMA, Kanagawa (JP); Yasuhisa OGATA, Kanagawa (JP); Maya UENO, Kanagawa (JP); Kenta KATSUMATA, Kanagawa (JP); Riko TANAKA, Kanagawa (JP); Akinori NOGUCHI, Kanagawa (JP)

(73) Assignee: SODICK CO., LTD., KANAGAWA (JP)

(21) Appl. No.: 16/882,533

(22) Filed: May 24, 2020

(30) Foreign Application Priority Data
May 28, 2019 (JP) 2019-099230
May 8, 2020 (JP) 2020-082332

(51) Int. Cl. A23L 3/01; A23L 7/109; A23L 5/30; A23L 3/00

(52) U.S. Cl. CPC A23L 3/01; A23L 3/001; A23L 5/34; A23L 7/109

(57) ABSTRACT

A granule preheating device, which preheats a granular food material stored at a low temperature to a predetermined preheating temperature suitable for processing before processing the granular food material with a food processing machine, includes: a housing that accommodates the granular food material, a stirring shaft that rotates a stirring blade to stir the granular food material in the housing, a microwave irradiation device that irradiates microwaves from above the granular food material in the housing, and a control device that controls at least the microwave irradiation device so as to preheat the granular food material being stirred by the stirring shaft until the temperature is uniformly increased to the predetermined preheating temperature of 25° C. or higher and 30° C. or lower suitable for processing within a predetermined preheating time of 10 minutes or less.

### CROSS-REFERENCE TO RELATED APPLICATIONS

This application claims the priority benefit of Japanese Patent Application No. 2019-099230, filed on May 28, 2019 and Japanese Patent Application No. 2020-082332, filed on May 8, 2020. The entirety of the above-mentioned patent application is hereby incorporated by reference herein and made a part of this specification.

### BACKGROUND

### Technical Field

The present disclosure relates to a granule preheating device and a granule preheating method thereof and a granule temperature adjustment device as well as a granule temperature adjustment method thereof, for preheating a granular food material being stored to a predetermined temperature suitable for processing before processing the granular food material with a food processing machine. In particular, the present disclosure relates to a granule preheating device and a granule preheating method thereof as well as a granule temperature adjustment device and a granule temperature adjustment method thereof, for preheating stored granules consisting of grains or legumes to a predetermined temperature suitable for processing before processing with a device that produces a dough of confectionery, bread or noodle.

### Related Art

The temperature of the food material processed by the food processing machine is a factor that directly affects the quality of a product after processing. The temperature suitable for processing of the food material immediately before processing with the food processing machine is derived from a relationship between processing characteristics of each component of the food material and the temperature.

In the case of most widely known granular food materials, the suitable temperature immediately before processing is a normal temperature of 25° C. or higher and 30° C. or lower. Accordingly, it is necessary to preheat or precool the granular food material until immediately before processing to uniformly increase or lower the overall temperature to a normal temperature. Besides, the food processing machines that process granular food materials include, for example, mixers, extruders, stirrers, crushers, and the like.

In addition, common granular food materials include, for example, wheat flour, barley flour, cornstarch, oat flour, rye flour, rice flour, rice flour, potato flour, sweet potato flour, buckwheat flour, soy flour, wheat grains, wheat grains, barley grains, corn grains, oats, rye grains, rice grains, buckwheat grains, sugar, salt, soy, and the like.

A known granule preheating device heats a granular food material accommodated in a housing with various heaters. For example, the heater may be a band heater wound around the outer periphery of the housing, a cartridge heater arranged in the housing, a hot air heater, and the like.

However, a granular food material containing components such as starch or protein is not suitable for temperature increase by direct heating because of a large change in processing characteristics attributed to heat. In addition, when the granular food material is densely packed, the granules are not in contact with each other with a sufficient area but in point-contact with each other. The granules in point-contact have a small thermal conduction area. Accordingly, the overall thermal conductivity of the granular food materials is low. Furthermore, convection of layers of air present between the granules cannot be expected due to a pressure loss when the air passes through a gap, and accordingly a phenomenon of thermal convection can be hardly expected.

Therefore, the temperature increase of food material performed by the granule preheating device requires a longer time for uniformly heating the whole food material to an appropriate temperature when the amount of granules increases. If a large temperature gradient is taken for shortening the time, the starch or protein contained in the food material changes more easily, and there is a risk that the food material is deteriorated and the quality of product is reduced. In particular, depending on a preservation method for food material, a common granular food material such as wheat flour is collectively stored in a storage such as a huge outdoor silo, and thus is stored at a low temperature of about 0° C.-9° C. on average in winter of Japan. It takes a longer time to increase the temperature of the food material to an appropriate temperature, which causes the reduction in operating rate of the food processing machine, and thus becomes a problem in terms of productivity improvement.

For example, it is disclosed that a microwave sterilization method and device for powder in patent literature 1 puts powder into a vertical mixer, generates a powder flow that rises in the center of the mixer and sinks at the periphery, irradiates the powder with microwaves from microwave oscillators disposed in a plurality of stages via each microwave guide tube while stirring and mixing the power, and heats the powder to 70° C. or higher and 83° C. or lower to sterilize the powder. It is disclosed that the powder in the mixer rises by 1° C. per minute due to the microwaves and is finally heated to 80° C.

### LITERATURE OF RELATED ART

### Patent Literature

[Patent literature 1] Japanese Patent No. 3557583

For the microwave sterilization device as disclosed in patent literature 1, for example, it takes 16 minutes to uniformly increase the temperature of powder stored at 9° C. to a normal temperature of 25° C. Microorganisms of which the existence in powder with limited moisture causes a problem are mainly spores of soil bacteria, and currently, a retort treatment which is a high-temperature treatment exceeding 100° C. is required to inactivate these spores. In addition, for example, when the food material is wheat flour, protein that plays an important role due to the characteristics during food processing is easily thermal-denatured from around 70° C., thus it is meaningless to degrade the processing characteristics even for sterilization purposes. Furthermore, because the cycle of using the mixer at the production site is about 10 minutes, the duration much longer than 10 minutes is undesirable in the production process.

It is desired that the whole granular food material is preheated uniformly from a low temperature of several degrees Celsius to a normal temperature of 25° C. or higher and 30° C. or lower in a shorter time. For example, as long as it is possible to uniformly and quickly preheat the granular food material to the normal temperature before processing with the food processing machine while minimizing a thermal change to starch or protein serving as a main component, the processing characteristics of each component is maintained, and the quality of the processed food is stabilized and improved.

### SUMMARY

An aspect of the present disclosure is to propose a granule preheating device and a granule preheating method thereof as well as a granule temperature adjustment device and a granule temperature adjustment method thereof, for uniformly preheating a granular food material being stored, by irradiating with microwaves while stirring, before processing with a food processing machine, and increasing the temperature to a predetermined preheating temperature suitable for processing, preferably, a predetermined preheating temperature of 25° C. or higher and 30° C. or lower, in a shorter time, desirably, within 10 minutes. Additional objects or advantages of the disclosure will be set forth in the description that follows.

The granule preheating device of the present disclosure, which preheats a granular food material stored at a low temperature to a predetermined preheating temperature suitable for processing before processing the granular food material with a food processing machine, includes: a housing that accommodates the food material, a stirring shaft that rotates a stirring blade to stir the food material in the housing, a microwave irradiation device that irradiates the food material in the housing with microwaves, and a control device that controls at least the microwave irradiation device so as to preheat the food material being stirred by the stirring shaft until the temperature is uniformly increased to the predetermined preheating temperature of 25° C. or higher and 30° C. or lower suitable for processing within a predetermined preheating time of 10 minutes or less.

In the granule preheating method of the present disclosure for preheating a granular food material stored at a low temperature to a predetermined preheating temperature suitable for processing before processing the granular food material with a food processing machine, the food material accommodated in the housing is irradiated with microwaves while being stirred so as to be uniformly preheated, and the preheating is performed until the temperature is increased to the predetermined preheating temperature of 25° C. or higher and 30° C. or lower within a predetermined preheating time of 10 minutes or less.

The granule temperature adjustment device of the present disclosure, which preheats or precools a granular food material being stored to a predetermined temperature suitable for processing before processing the granular food material with a food processing machine, includes: a housing that accommodates the food material, a stirring shaft that rotates a stirring blade to stir the food material in the housing, a granule precooling unit that precools the food material in the housing, a granule preheating unit that preheats the food material in the housing, a temperature sensor that detects the temperature of the food material in the housing, and a control device that controls at least the granule precooling unit and the granule preheating unit based on the temperature detected by the temperature sensor. The granule preheating unit includes a microwave irradiation device that irradiates the food material in the housing with microwaves. The control device controls at least the microwave irradiation device so as to preheat the food material being stirred by the stirring shaft until the temperature is uniformly increased to the predetermined temperature of 25° C. or higher and 30° C. or lower suitable for processing within a predetermined preheating time of 10 minutes or less, when the temperature of the food material in the housing is lower than the predetermined temperature.

In the granule temperature adjustment method of the present disclosure for preheating or precooling a granular food material being stored to a predetermined temperature suitable for processing before processing the granular food material with a food processing machine, when the temperature of the food material accommodated in the housing is lower than the predetermined temperature, the food material accommodated in the housing is irradiated with microwaves while being stirred so as to be uniformly preheated, and the preheating is performed until the temperature is increased to a predetermined temperature of 25° C. or higher and 30° C. or lower within a predetermined preheating time of 10 minutes or less.

### BRIEF DESCRIPTION OF THE DRAWINGS

FIG. 1 is a schematic view of an internal structure of a granule preheating device according to an embodiment of the present disclosure, as viewed from the front.

FIG. 2 is a schematic view of the internal structure of the granule preheating device when a lid member is closed, as viewed from the left side.

FIG. 3 is a schematic view of the internal structure of the granule preheating device when the lid member is opened, as viewed from the left side.

FIG. 4 is a schematic view of the internal structure of the granule preheating device when a housing is turned over with the lid member opened, as viewed from the left side.

FIG. 5 is a schematic view of a front end shape of a rod-shaped stirring blade.

FIG. 6 is a schematic view of another front end shape of the rod-shaped stirring blade.

FIG. 7 is a schematic view of still another front end shape of the rod-shaped stirring blade.

FIG. 8 is a schematic view of a series of systems in which a granular food material moves from a silo to a food processing machine through the granule preheating device.

FIG. 9 is a schematic front view of a granule preheating device of another embodiment according to the embodiment of the present disclosure.

FIG. 10 is a schematic plan view of the granule preheating device of another embodiment.

FIG. 11 is a schematic front view of a stirring member of the granule preheating device of another embodiment.

FIG. 12 is a schematic plan view of the stirring member of the granule preheating device of another embodiment.

FIG. 13 is a schematic front view of a granule temperature adjustment device according to the embodiment of the present disclosure.

FIG. 14 is a schematic plan view of the granule temperature adjustment device.

FIG. 15 is a schematic front view of a stirring member of the granule temperature adjustment device.

### DESCRIPTION OF THE EMBODIMENTS

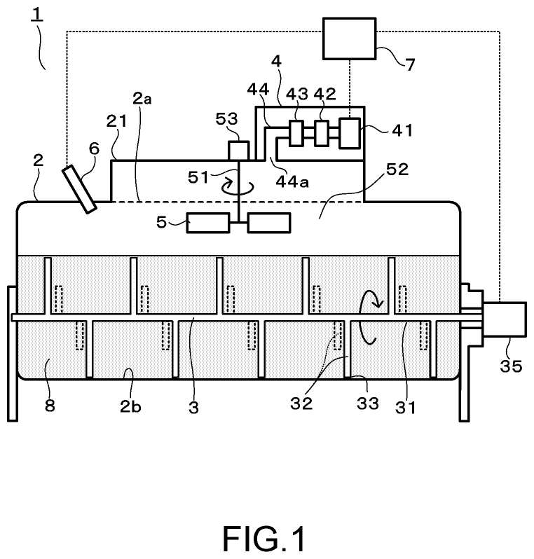

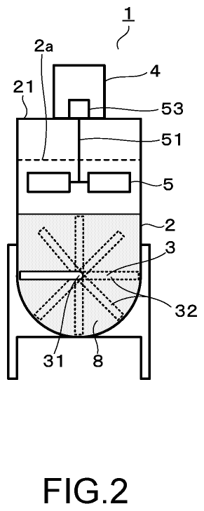

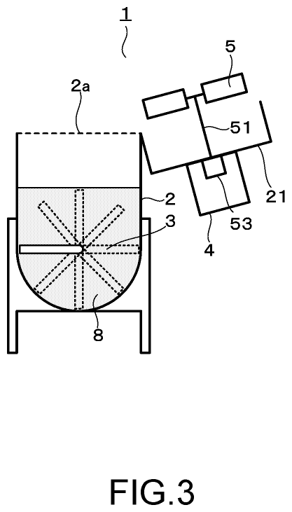

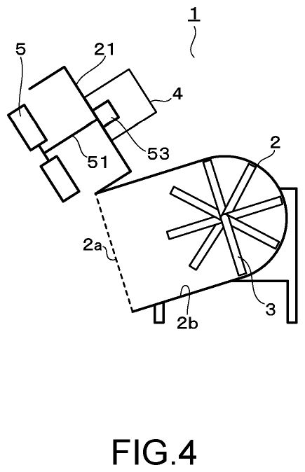

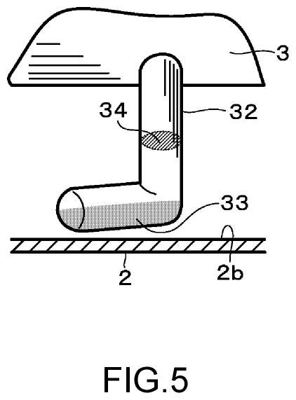

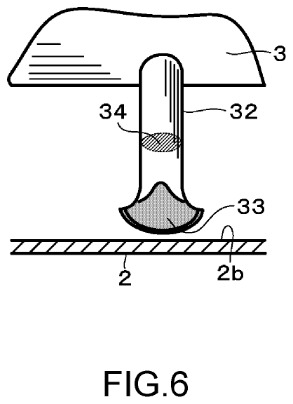

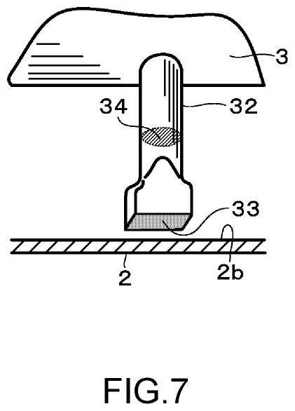

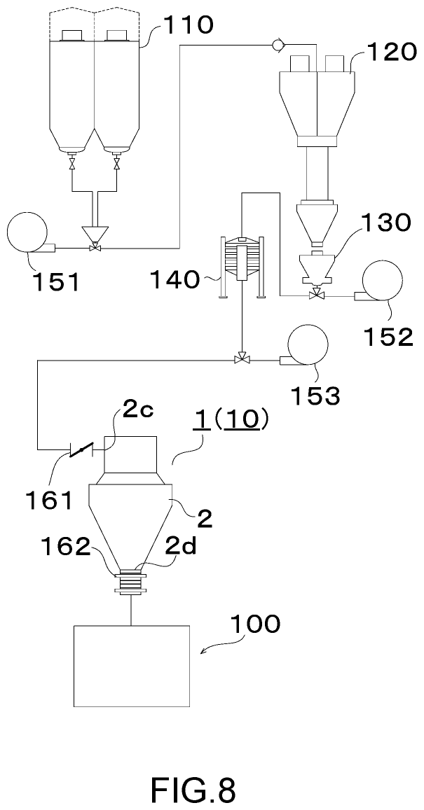

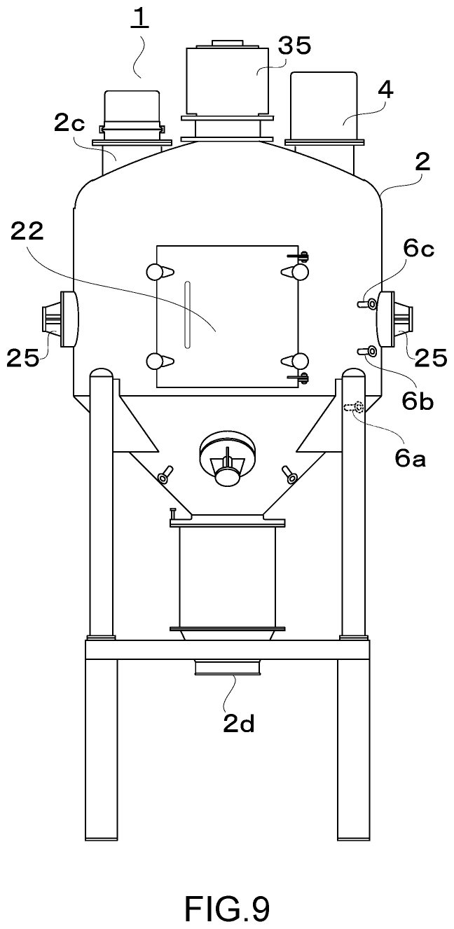

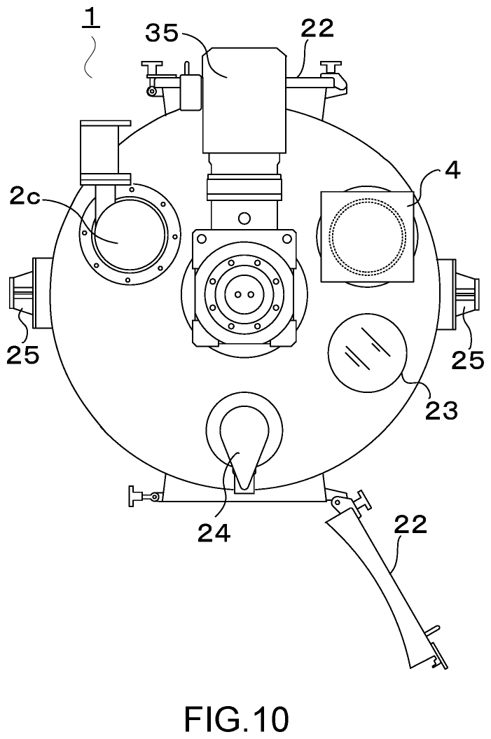

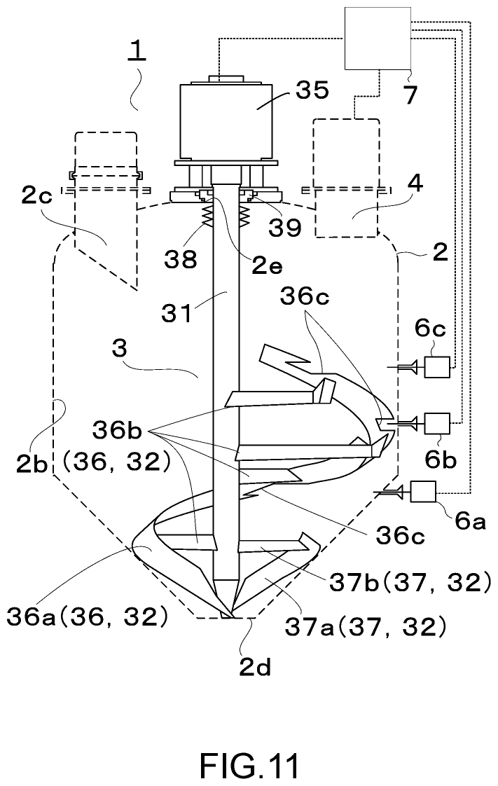

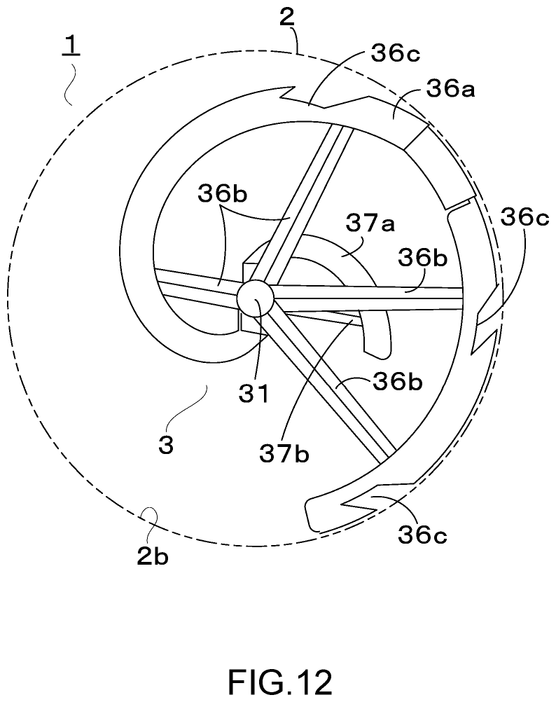

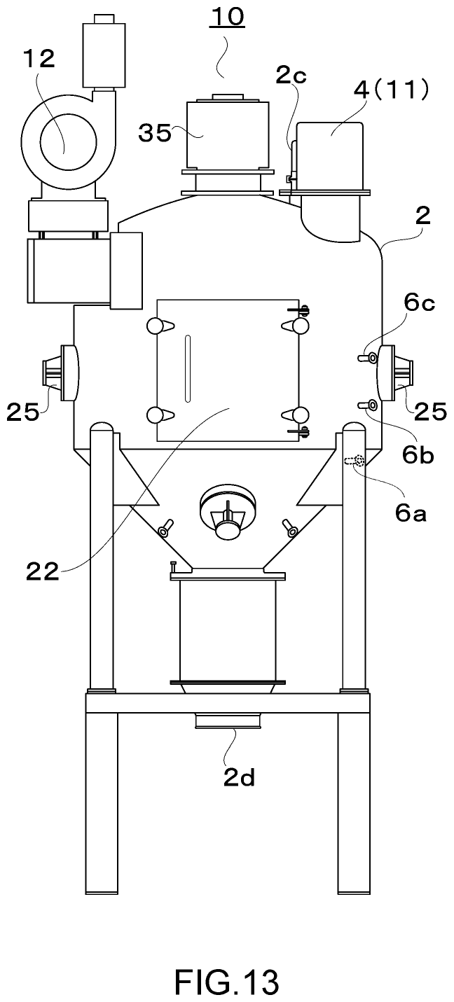

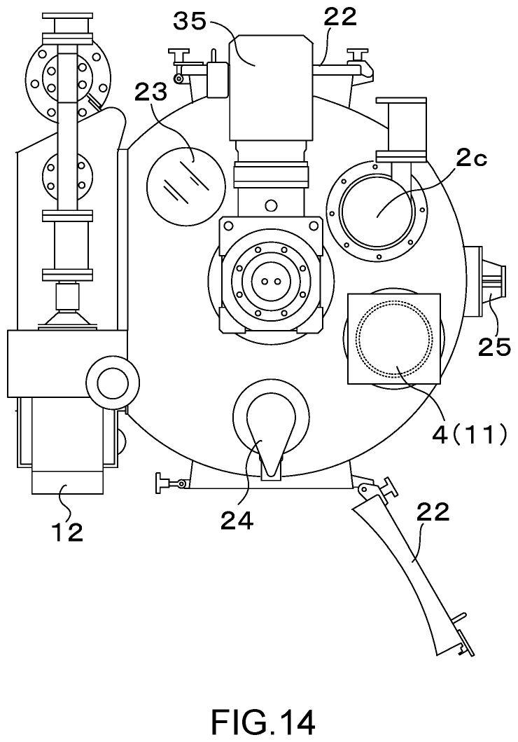

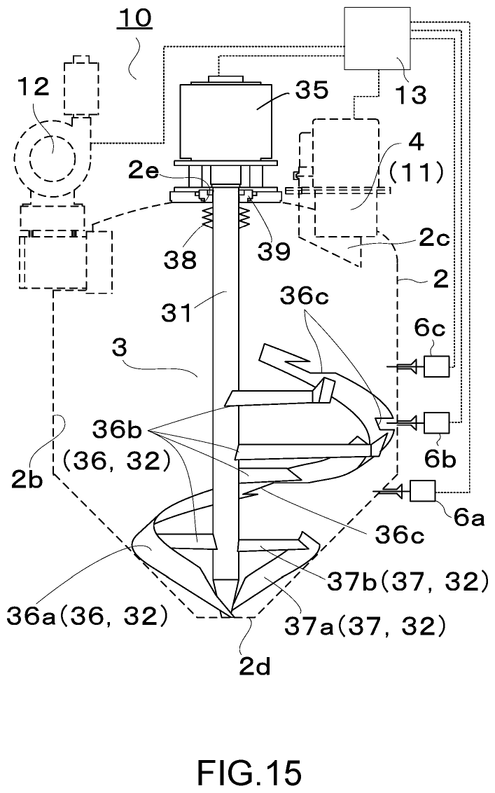

Hereinafter, embodiments of the present disclosure are described in detail with reference to the drawings. FIG. 1 is a schematic view of an internal structure of a granule preheating device according to an embodiment of the present disclosure, as viewed from the front. FIG. 2 is a schematic view of the internal structure of the granule preheating device when a lid member is closed, as viewed from the left side. FIG. 3 is a schematic view of the internal structure of the granule preheating device when the lid member is opened, as viewed from the left side. FIG. 4 is a schematic view of the internal structure of the granule preheating device when a housing is turned over with the lid member opened, as viewed from the left side. FIG. 5 is a schematic view of a front end shape of a rod-shaped stirring blade. FIG. 6 is a schematic view of another front end shape of the rod-shaped stirring blade. FIG. 7 is a schematic view of still another front end shape of the rod-shaped stirring blade. FIG. 8 is a schematic view of a series of systems in which a granular food material moves from a silo to a food processing machine through the granule preheating device. FIG. 9 is a schematic front view of a granule preheating device of another embodiment according to the embodiment of the present disclosure. FIG. 10 is a schematic plan view of the granule preheating device of another embodiment. FIG. 11 is a schematic front view of a stirring member of the granule preheating device of another embodiment. FIG. 12 is a schematic plan view of the stirring member of the granule preheating device of another embodiment. FIG. 13 is a schematic front view of a granule temperature adjustment device according to the embodiment of the present disclosure. FIG. 14 is a schematic plan view of the granule temperature adjustment device. FIG. 15 is a schematic front view of a stirring member of the granule temperature adjustment device. Besides, the up-down direction is an up-down direction when FIGS. 1 and 9 are viewed from the front. The left-right direction is a left-right direction when FIGS. 1 and 9 are viewed from the front. In the front-rear direction, the front side when FIGS. 1 and 9 are viewed from the front is a front direction and the rear side is a rear direction. The horizontal directions are horizontal two-axis directions formed in the front-rear direction and the left-right direction. The vertical direction is the up-down direction.

A granule preheating device 1 of the present disclosure includes, for example, as in the embodiment shown in FIGS. 1-7, a housing 2, a stirring shaft 3, a microwave irradiation device 4, a stirrer fan 5, a temperature sensor 6, and a control device 7.

The housing 2 accommodates a granular food material 8 before processing with a food processing machine described later. The housing 2 is horizontally placed in the horizontal directions. The housing 2 may be horizontally long. The housing 2 is horizontally placed so that the longitudinal direction is a left-right direction. The lower part of the housing 2 may have a circular cross section in a direction perpendicular to the longitudinal direction of the housing 2. The housing 2 may be made of, for example, metal or stainless steel.

A lid member 21 capable of opening and closing a material supply/discharge port 2a that is open at the upper part of the housing 2 is attached. The granular food material 8 is taken in and out of the housing 2 from the material supply/discharge port 2a with the lid member 21 opened. After the lid member 21 is opened as shown in FIG. 3, the granular food material 8 in the housing 2 may be discharged by its own weight from the material supply/discharge port 2a by turning over the housing 2 with the longitudinal direction of the housing 2 as a rotation shaft as shown in FIG. 4. By rotating the stirring shaft 3 when the housing 2 is turned over, the granular food material 8 may be quickly discharged from the material supply/discharge port 2a while the fluidity of the granular food material 8 is maintained.

The stirring shaft 3 stirs the granular food material 8 in the housing 2. The stirring shaft 3 is rotatably arranged in the housing 2. The axial direction of a rotation shaft 31 of the stirring shaft 3 is arranged in the horizontal direction. The axial direction of the rotation shaft 31 of the stirring shaft 3 is arranged so as to be in the same left-right direction as the longitudinal direction of the housing 2 placed horizontally. A stirring shaft rotation drive device 35 rotates the rotation shaft 31 of the stirring shaft 3. The stirring shaft 3 includes a stirring blade 32. The stirring blade 32 is attached to the rotation shaft 31. The granular food material 8 in the housing 2 is stirred by the rotating stirring blade 32. The stirring shaft 3 may be made of, for example, metal or stainless steel.

The stirring blade 32 may be formed in a rod shape. Preferably, the stirring blade 32 is configured so that the area of a front end surface 33 of the rod facing the inner surface of a wall 2b of the housing 2 is larger than the area of a cross section 34 of a body portion of the rod perpendicular to the longitudinal direction of the rod. For example, as shown in FIG. 5, the front end surface 33 of the rod-shaped stirring blade 32 may be a surface facing the inner surface of the wall 2b of the housing 2 among the front end part of the rod bent at 90 degrees. In addition, for example, as shown in FIG. 6, a part of the outer edge of the front end surface 33 of the rod-shaped stirring blade 32 may be a curved surface. In addition, for example, as shown in FIG. 7, a part of the outer edge of the front end surface 33 of the rod-shaped stirring blade 32 may be a straight surface. In particular, the front end surface 33 of the rod-shaped stirring blade 32 may have a small number of corners and be a plane so as not to concentrate energy from microwaves.

The microwave irradiation device 4 irradiates the granular food material 8 in the housing 2 with microwaves. Besides, the microwaves irradiated into the housing 2 with the lid member 21 closed efficiently heat the granular food material 8 without leaking out of the housing 2. When the granular food material 8 is taken in or out of the housing 2, the microwave irradiation device 4 stops the irradiation of the microwaves.

The microwave irradiation device 4 includes at least a microwave oscillator 41, an isolator 42, an EH tuner 43, and a waveguide 44. In the microwave irradiation device 4, the microwave oscillator 41, the isolator 42, the EH tuner 43, and the housing 2 are connected in this order by the waveguide 44.

The microwave oscillator 41 oscillates microwaves. The microwave oscillator 41 is, for example, a general magnetron of 2450 MHz band. The moisture contained in the granular food material 8 absorbs the microwaves and generates heat.

The isolator 42 propagates a traveling wave of the microwaves oscillated from the microwave oscillator 41 and absorbs a reflected wave of the microwaves. The isolator 42 prevents the reflected wave of the microwaves oscillated from the microwave oscillator 41 from returning to the microwave oscillator 41.

The EH tuner 43 generates a wave having the same amplitude and the opposite phase as the reflected wave returning from the inside of the housing 2. The EH tuner 43 creates a matching state in which the reflected wave returning from the inside of the housing 2 is offset.

The waveguide 44 propagates the microwaves. The waveguide 44 is connected to a housing-side opening 44a of the lid member 21 at the upper part of the housing 2 and propagates the microwaves into the housing 2. The microwaves may be irradiated from above the granular food material 8 in the housing 2.

The stirrer fan 5 increases the cavitation of the microwaves irradiated into the housing 2. The stirrer fan 5 is rotatably arranged in the housing 2. The axial direction of a rotation shaft 51 of the stirrer fan 5 is arranged in the up-down direction. A stirrer fan rotation drive device 53 rotates the rotation shaft 51 of the stirrer fan 5.

A reflection plate 52 is attached to the stirrer fan 5. The reflection plate 52 of the stirrer fan 5 is disposed in a space between the housing-side opening 44a of the waveguide 44 and the granular food material 8 in the housing 2. The stirrer fan 5 is arranged above the granular food material 8. The stirrer fan 5 scatters the microwaves irradiated from the housing-side opening of the waveguide 44 above the granular food material 8 in the housing 2, and uniformly irradiates the microwaves toward the upper surface of the granular food material 8.

The temperature sensor 6 detects the temperature of the granular food material 8 in the housing 2. For example, as shown in FIG. 1, the temperature sensor 6 may be a radiation thermometer capable of detecting the temperature of the granular food material 8 in a non-contact manner. As the temperature sensor 6, for example, a sensor that uses an optical fiber sensor to detect the temperature may be employed.

The control device 7 is connected to the microwave irradiation device 4, and controls at least the microwave irradiation device 4 so as to irradiate the granular food material 8 being stirred by the stirring shaft 3 in the housing 2 with microwaves, and preheat the granular food material 8 in the housing 2 until the temperature is uniformly increased to a predetermined preheating temperature within a predetermined preheating time. The control device 7 may be connected to the temperature sensor 6, receive a signal indicating the temperature detected by the temperature sensor 6, and control at least the microwave irradiation device 4 based on the temperature detected by the temperature sensor 6. In addition, the control device 7 may be connected to the stirring shaft rotation drive device 35 and the stirrer fan rotation drive device 53 to control them.

In particular, in the granule preheating device 1 and the granule preheating method of the present disclosure, by accommodating the granular food material 8 stored at a low temperature into the housing 2 before processing with the food processing machine, stirring the granular food material 8 in the housing 2, and irradiating the granular food material 8 being stirred in the housing 2 with microwaves, preheating can be performed until the temperature of the granular food material 8 stored at a low temperature is uniformly increased to a predetermined preheating temperature of 25° C. or higher and 30° C. or lower, which is suitable for processing with the food processing machine, within a predetermined preheating time of 10 minutes or less.

The amount of heat energy necessary for increasing the temperature of most granular food materials 8 is smaller than the amount of heat energy necessary for increasing the temperature of water. For example, the specific heat of wheat is 1.524 J/g·K. The specific heat of water is 4.217 J/g·K. The specific heat of wheat is about one third of the specific heat of water.

For example, a food material with starch and protein as main components can be increased in temperature in a shorter time within the range of a temperature difference of 15° C.-30° C. when utilizing the temperature increase of moisture that is naturally present as free water on the surface layers of those components. Besides, the moisture amount of the granular food material generally distributed in the market is regulated to a fixed range. For example, the moisture content of flour is about 13-15%.

Therefore, a microwave having a very large induced loss coefficient with respect to water is used for preheating. The microwave actively heats the moisture contained in the granular food material 8. The microwave can increase the temperature of the granular food material 8 to a normal temperature suitable for processing in a short time before processing. In addition, the short preheating time can keep the heat of the moisture generated by the microwave to the minimum necessary amount and can suppress the reduction in quality of the granular food material 8 without increasing the temperature to a temperature band in which changes caused by heat are generated in the components such as starch and protein that have a large change in processing characteristics due to heat.

Furthermore, the microwave does not directly heat the components having large changes in processing characteristics due to heat, such as starch and protein contained in the granular food material 8, and thus the reduction in quality of the granular food material 8 can be suppressed.

In the granular food material 8 supplied into the housing 2, there may be a place where a gap between powders or a gap between particles is wide and a place where the gap is narrow. The place where the gap is wide has a longer distance by which the microwave penetrates without attenuating than the place where the gap is narrow. The granular food material 8 in the place where the gap is wide is more easily heated than the granular food material 8 in the place where the gap is narrow.

Therefore, the granular food material 8 is irradiated with microwaves to be preheated while being stirred in the housing 2. By stirring, the temperature of the granular food material can be more uniformly increased in a short time. At this time, due to the cavitation in the housing, the temperature of the granular food material can be increased more quickly and uniformly.

In the granule preheating device 1 of the present disclosure, the granular food material 8 is supplied into the housing 2, and the granular food material 8 is irradiated with microwaves in the housing 2 while the granular food material 8 is stirred by the stirring shaft 3 in the housing 2, and thereby the granular food material can be efficiently preheated. Because the microwaves are prevented from leaking by the housing 2, the heating efficiency is high.

Hereinafter, the granule preheating device 1 of the present disclosure is described in more detail by another embodiment. Besides, the description of the same components as those in the above embodiment is omitted.

As shown in FIG. 8, the granule preheating device 1 preheats the granular food material 8 stored at a low temperature in a silo 110 to a predetermined preheating temperature suitable for processing before processing the granular food material 8 with a food processing machine 100.

The granular food material 8 stored in the silo 110 is transmitted to a use bin 120 by a blower 151. The use bin 120 is a temporary storage tank. The granular food material 8 stored in the use bin 120 is measured by a scale 130 for a predetermined amount. The scale 130 is a weighing device. The predetermined amount of granular food materials 8 is transmitted to an inline shifter 140 by a blower 152. The inline shifter 140 continuously passes the granular food material 8 through a vibrating sieve to remove foreign matter. The granular food material 8 from which foreign matter has been removed is transmitted to the granule preheating device 1 by a blower 153. The blowers 151, 152 and 153 are pneumatic movable devices.

The granular food material 8 transmitted to the granule preheating device 1 is preheated to a predetermined preheating temperature suitable for food processing. The preheated granular food material 8 moves to the food processing machine 100 by its own weight. Besides, as means for transporting the granular food material 8, various methods may be employed as necessary.

The food processing machine 100 is, for example, a machine that produces a dough of confectionery, bread or noodle. For example, the food processing machine 100 is a mixer that adds water to and kneads the granular food material 8 to produce the dough. In addition, for example, the food processing machine 100 is an extruder that has a rotating screw and extrudes the dough into a specific shape.

The granular food material 8 is either a powdery food material or a particle food material, or a mixture thereof. The granular food material 8 includes, for example, wheat flour, barley flour, corn starch, oat flour, rye flour, rice flour, potato flour, buckwheat flour, soy flour, wheat grains, barley grains, corn grains, oats, rye grains, rice grains, buckwheat berries, and soybeans.

As shown in FIGS. 9 and 10, the housing 2 of the granule preheating device 1 may be vertically placed in the vertical direction. The housing 2 may be vertically long. The housing 2 is placed vertically so that the longitudinal direction is the up-down direction. A part of the housing 2 from the upper part to the body portion has a cylindrical shape. A material supply port 2c is formed at the upper part of the housing 2. The lower part of the housing 2 has an inverted conical shape whose diameter is reduced downward, and the inner side of the lower part of the housing 2 has a funnel shape. A material discharge port 2d is formed at the lower part of the housing 2. The housing 2 may be made of, for example, metal or stainless steel.

The material supply port 2c of the housing 2 is an inlet for supplying, into the housing 2, the granular food material 8 from which foreign matter has been removed by the inline shifter 140. The material discharge port 2d of the housing 2 is an outlet for discharging the granular food material 8 preheated in the housing 2 toward the food processing machine 100. The material supply port 2c and the material discharge port 2d can be opened and closed respectively by on-off valves 161 and 162.

Inspection doors 22 and 22 are arranged on the front surface and the back surface of the housing 2. The inspection doors 22 and 22 are opened when the inside of the housing is cleaned. An inspection window 23 is arranged at the upper part of the housing 2. The inspection window 23 is, for example, colorless and transparent glass, plastic or the like, and makes the inside of the housing 2 visible. An illumination member 24 is arranged at the upper part of the housing. The illumination member 24 illuminates the inside of the housing 2 when the inside of the housing 2 is viewed from the inspection window 23. A vibration member 25 is arranged on the side surface of the housing 2. The vibration member 25 is, for example, a pneumatic or electromagnetic knocker or the like, and enables, by vibrating the housing 2, the granular food material adhered to the inner surface of the wall 2b of the housing 2 to reliably drop from the material discharge port 2d.

The microwave irradiation device 4 is arranged at the upper part of the housing 2. The microwave irradiation device 4 irradiates the granular food material 8 in the housing 2 with microwaves. The microwaves are irradiated from above the granular food material 8. For example, the microwaves repeat irregular reflection in the housing 2 made of stainless steel to heat the granular food material 8.

A plurality of temperature sensors 6a, 6b and 6c is arranged in the housing 2. The plurality of temperature sensors 6a, 6b and 6c is arranged so that the heights from the material discharge port 2d are different from each other. For example, the temperature sensor 6a is arranged at a position lower than the temperature sensors 6b and 6c. The temperature sensor 6c is arranged at a position higher than the temperature sensors 6a and 6b. The temperature sensor 6b is arranged between the temperature sensor 6a and the temperature sensor 6c. The plurality of temperature sensors 6a, 6b and 6c detects the temperature of the granular food material 8 at positions respectively different in height from the material discharge port 2d. Besides, for example, when the granular food material 8 in the housing 2 is accommodated up to the height between the temperature sensor 6b and the temperature sensor 6c, only the temperature sensor 6c may be used. The plurality of temperature sensors 6a, 6b and 6c may be, for example, resistance temperature detectors.

As shown in FIGS. 11 and 12, the rotation shaft 31 of the stirring shaft 3 is arranged so that the axial direction thereof is oriented in the perpendicular direction. The rotation shaft 31 of the stirring shaft 3 is arranged in the same direction as the up-down direction of the housing 2 placed vertically. The base end of the rotation shaft 31 is connected to the stirring shaft rotation drive device 35 arranged at the upper part of the housing 2. The front end of the rotation shaft 31 faces the material discharge port 2d. The stirring shaft 3 has the stirring blade 32. The stirring blade 32 is configured by a main stirring blade 36 and an auxiliary stirring blade 37. The stirring shaft 3 may be made of, for example, metal or stainless steel.

The main stirring blade 36 is configured by a main blade body 36a and main blade attachment shafts 36b. When viewed from the front as shown in FIG. 11, the main blade body 36a is formed in a shape in which the band-shaped blade is spirally wound along the inner surface of the wall 2b of the housing 2 at a fixed interval from the peripheral surface of the rotation shaft 31. In addition, in a plane view as shown in FIG. 12, the main blade body 36a is formed in a helical shape so as to approach the rotation shaft 31 as the band-shaped blade swirls, and a radius of curvature becomes smaller from the upper side toward the lower side of the housing 2. In addition, main blade cutouts 36c, 36c and 36c are formed on the outer periphery of the main blade body 36a. The main blade cutouts 36c, 36c and 36c are formed so that the main blade body 36a does not collide with the temperature sensors 6a, 6b and 6c arranged in the housing 2.

The auxiliary stirring blade 37 is configured by an auxiliary blade body 37a and an auxiliary blade attachment shaft 37b. The auxiliary stirring blade 37 is a blade disposed below the main stirring blade 36 and is attached to the front end of the rotation shaft 31 via the auxiliary blade attachment shaft 37b. Similar to the main blade body 36a, the auxiliary blade body 37a is formed in a shape in which the band-shaped blade is spirally wound by a half turn along the inner surface of the wall 2b of the housing 2 at a fixed interval from the peripheral surface of the rotation shaft 31, and the auxiliary blade body 37a is formed in a helical shape so as to approach the rotation shaft 31 as the band-shaped blade swirls. In addition, the main blade body 36a and the auxiliary blade body 37a are arranged at point-symmetric positions centering on the rotation shaft 31. Similar to the main blade body 36a, the auxiliary blade body 37a may have auxiliary blade cutouts not shown.

Because the main stirring blade 36 and the auxiliary stirring blade 37 have a spiral and helical shape along the inner surface of the wall 2b of the housing 2, the granular food material 8 in the housing 2 can be sufficiently mixed so that the upper and lower layers are exchanged from the bottom of the housing 2 when the stirring shaft 3 rotates, and gaps are formed between the granules and the lower layer can be prevented from being consolidated.

The rotation shaft 31 of the stirring shaft 3 is rotatably inserted into a through hole 2e that penetrates the wall 2b of the housing 2. The space between the rotation shaft 31 and the through hole 2e is sealed by a seal ring such as an oil seal and an O-ring. A seal attachment member 39 may be arranged between the rotation shaft 31 and the through hole 2e. For example, a first seal ring, a second seal ring, and a third seal ring are attached to the seal attachment member 39. The space between the seal attachment member 39 and the rotation shaft 31 is sealed by, for example, the first seal ring. The space between the seal attachment member 39 and the through hole 2e is sealed by, for example, the second seal ring and the third seal ring.

The rotation shaft 31 of the stirring shaft 3 may have a bellows-like annular portion 38 in the housing 2 and on the outer periphery near the through hole 2e. The bellows-like annular portion 38 may be arranged in the housing 2 so that the stirring shaft is rotatably inserted into the housing and near the through hole. The bellows-like annular portion 38 is arranged in the housing 2 and near the seal ring or the seal attachment member 39. The housing 2 may include the seal ring or the seal attachment member 39. The bellows-like annular portion 38 may be attached to the seal ring or the seal attachment member 39. In the bellows-like annular portion 38, parts having a large outer diameter and parts having a small outer diameter may be arranged alternately in the axial direction of the central axis. The bellows-like annular portion 38 may be made of, for example, metal or stainless steel. The microwaves reflected inside the housing 2 are reflected by the bellows-like annular portion 38 before reaching the seal ring and the seal attachment member 39. The bellows-like annular portion 38 can, for example, prevent the seal attachment member 39 and the seal ring made of resin from being heated by the microwaves.

Hereinafter, a granule temperature adjustment device 10 of the present disclosure is described. Besides, the description of the same components as those of the above granule preheating device 1 is omitted. In addition, the food processing machine 100, the silo 110, the use bin 120, the scale 130, the inline shifter 140, the blowers 151, 152 and 153, and the on-off valves 161 and 162 also have the same configurations as those described above, and thus the description thereof is omitted.

As shown in FIG. 8, the granule temperature adjustment device 10 preheats or precools the granular food material 8 stored in the silo 110 to a predetermined temperature suitable for processing before processing the granular food material 8 with the food processing machine 100.

As shown in FIGS. 13-15, the granule temperature adjustment device 10 includes the housing 2, the stirring shaft 3, a granule preheating unit 11, a granule precooling unit 12, the temperature sensors 6a, 6b and 6c, and a control device 13.

The granule preheating unit 11 preheats the granular food material 8 in the housing 2. The granule preheating unit 11 includes the microwave irradiation device 4 and irradiates the granular food material 8 in the housing 2 with microwaves. The granular food material in the housing 2 is preheated by the microwaves irradiated from the microwave irradiation device 4 while being stirred by the stirring shaft 3.

The granule precooling unit 12 precools the granular food material 8 in the housing 2. The granule precooling unit 12 includes, for example, a vacuum device not shown and depressurizes the inside of the housing 2 in which the granular food material 8 is accommodated. The vacuum device is, for example, a vacuum pump; the vacuum device reduces the pressure in the housing 2 to a pressure or lower at which moisture is evaporated, forcibly evaporates a part of the moisture maintained by the granular food material 8 in the housing 2, and cools the granular food material 8 in the housing 2 using the latent heat at that time. The granular food material 8 in the housing 2 is cooled while being stirred by the stirring shaft 3 to thereby be uniformly cooled. In addition, a cold trap not shown may be arranged between the housing 2 and the vacuum pump. The cold trap is a device capable of removing moisture contained in a gas, and can quickly recover the water vapor that has been forcibly evaporated from the granular food material 8 by the vacuum pump. The cold trap rapidly reduces the amount of water vapor in the housing 2, increases the rising rate in the degree of vacuum in the housing 2, and more quickly reduces the temperature of the granular food material 8 in the housing 2. The cold trap is, for example, a heat exchanger configured so that a refrigerant is circulated in a pipe and gaseous moisture is condensed. Besides, the granule precooling unit 12 is not limited to the vacuum device described above, and various cooling means can be employed.

The control device 13 is connected to and controls the granule preheating unit 11 and the granule precooling unit 12. In addition, the control device 13 may be connected to the temperature sensors 6a, 6b and 6c, receive a signal indicating the temperature detected by the temperature sensors 6a, 6b and 6c, and control the granule preheating unit 11 and the granule precooling unit 12 based on the temperature detected by the temperature sensors 6a, 6b and 6c. In addition, the control device 13 may be connected to the stirring shaft rotation drive device 35 and control the stirring shaft rotation drive device 35. In addition, when a stirrer fan is included, the control device 13 may control the stirrer fan rotation drive device.

When the temperature of the granular food material 8 in the housing 2 is lower than the predetermined temperature, the control device 13 stirs the food material in the housing 2 by the stirring shaft 3, and controls at least the microwave irradiation device 4 so as to perform preheating until the temperature is uniformly increased to a predetermined temperature of 25° C. or higher and 30° C. or lower suitable for processing within a predetermined preheating time of 10 minutes or less. The predetermined temperature at this time is a preheating temperature.

In addition, when the temperature of the granular food material 8 in the housing 2 is higher than the predetermined temperature, the control device 13 controls the granule precooling unit 12 so as to perform precooling until the granular food material 8 in the housing 2 is uniformly cooled to the predetermined temperature. The predetermined temperature at this time is a precooling temperature.

In particular, in the granule temperature adjustment device 10 and the granule temperature adjustment method of the present disclosure, the stored granular food material 8 is accommodated in the housing 2 before being processed with the food processing machine 100. When the temperature of the granular food material 8 in the housing 2 is lower than a predetermined temperature, the granular food material 8 accommodated in the housing 2 is irradiated with microwaves while being stirred to thereby be uniformly preheated, and the preheating can be performed until the temperature is increased to a predetermined temperature of 25° C. or higher and 30° C. or lower suitable for processing with the food processing machine 100 within a predetermined preheating time of 10 minutes or less.

By uniformly increasing the temperature of a granular food material being stored to a normal temperature of 25° C.-30° C. suitable for processing within 10 minutes before processing with a food processing machine, the granule preheating device and the granule preheating method thereof as well as the granule temperature adjustment device and the granule temperature adjustment method thereof of the present disclosure can further improve the quality of processed food after the processing with the food processing machine.

The embodiment was chosen in order to explain the principles of the disclosure and its practical application. Many modifications and variations are possible in light of the above teachings. It is intended that the scope of the disclosure be defined by the claims.

What is claimed is:

1. A granule preheating device which preheats a granular food material stored at a low temperature to a predetermined preheating temperature suitable for processing before processing the granular food material with a food processing machine, the granule preheating device comprising:
a housing that accommodates the granular food material,
a stirring shaft that rotates a stirring blade to stir the granular food material in the housing,
a microwave irradiation device that irradiates the granular food material in the housing with microwaves, and
a control device that is configured to control at least the microwave irradiation device so as to preheat the granular food material being stirred by the stirring shaft until the temperature is uniformly increased to the predetermined preheating temperature of 25° C. or higher and 30° C. or lower suitable for processing within a predetermined preheating time of 10 minutes or less.

2. The granule preheating device according to claim 1, further comprising a stirrer fan that rotates above the food material in the housing to scatters the microwaves above the food material,
wherein the microwaves are irradiated from above the stirrer fan.

3. The granule preheating device according to claim 1, wherein the housing is horizontally placed in a horizontal direction, and
the axial direction of a rotation shaft of the stirring shaft is the horizontal direction.

4. The granule preheating device according to claim 1, wherein the housing is vertically placed in a vertical direction, and
the axial direction of a rotation shaft of the stirring shaft is the vertical direction.

5. The granule preheating device according to claim 1, wherein the stirring blade is formed in a shape of being spirally wound along the inner surface of a wall of the housing.

6. The granule preheating device according to claim 5, wherein the stirring blade is configured by a main blade and an auxiliary blade.

7. The granule preheating device according to claim 1, wherein the stirring blade is formed in a rod shape, and the area of a front end surface of the rod facing the inner surface of the housing is larger than the area of a cross section of a body portion of the rod perpendicular to the longitudinal direction of the rod.

8. The granule preheating device according to claim 1, wherein a rotation shaft of the stirring shaft is rotatably inserted into a through hole penetrating a wall of the housing, and
the rotation shaft has a bellows-like annular portion in the housing and on the outer periphery near the through hole.

9. The granule preheating device according to claim 1, wherein a rotation shaft of the stirring shaft is rotatably inserted into a through hole penetrating a wall of the housing, and
the housing has a bellows-like annular portion in which the stirring shaft is rotatably inserted into the housing and near the through hole.

10. The granule preheating device according to claim 1, further comprising a temperature sensor that detects the temperature of the food material in the housing, and
the control device is configured to control at least the microwave irradiation device based on the temperature detected by the temperature sensor.

11. The granule preheating device according to claim 1, wherein the food material comprises: wheat flour, barley flour, corn starch, oat flour, rye flour, rice flour, potato flour, buckwheat flour, soy flour, wheat grains, barley grains, corn grains, oats, rye grains, rice grains, buckwheat berries, and soybeans.

12. The granule preheating device according to claim 1, wherein the food processing machine produces a dough of confectionery, bread or noodle.

13. The granule preheating device according to claim 12, wherein the food processing machine is a mixer that adds water into and kneads the food material to produce the dough.

14. The granule preheating device according to claim 12, wherein the food processing machine is an extruder that has a rotating screw and extrudes the dough into a specific shape.

15. A granule preheating method for preheating a granular food material stored at a low temperature to a predetermined preheating temperature suitable for processing before processing the granular food material with a food processing machine,
wherein the food material accommodated in the housing is irradiated with microwaves while being stirred so as to be uniformly preheated, and the preheating is performed until the temperature is increased to the predetermined preheating temperature of 25° C. or higher and 30° C. or lower within a predetermined preheating time of 10 minutes or less.

16. The granule preheating method according to claim 15, wherein the microwaves are scattered by a stirrer fan.

17. A granule temperature adjustment device which preheats or precools a granular food material being stored to a predetermined temperature suitable for processing before processing the granular food material with a food processing machine, the granule temperature adjustment device comprising:
a housing that accommodates a food material,
a stirring shaft that rotates a stirring blade to stir the food material in the housing,
a granule precooling unit that precools the food material in the housing,
a granule preheating unit that preheats the food material in the housing,
a temperature sensor that detects the temperature of the food material in the housing, and
a control device that is configured to control at least the granule precooling unit and the granule preheating unit based on the temperature detected by the temperature sensor;
wherein the granule preheating unit comprises
a microwave irradiation device that irradiates the food material in the housing with microwaves; and
the control device is configured to control at least the microwave irradiation device so as to preheat the granular food material being stirred by the stirring shaft until the temperature is uniformly increased to the predetermined temperature of 25° C. or higher and 30° C. or lower suitable for processing within a predetermined preheating time of 10 minutes or less, when the temperature of the food material in the housing is lower than the predetermined temperature.

18. A granule temperature adjustment method for preheating or precooling a granular food material being stored to a predetermined temperature suitable for processing before processing the granular food material with a food processing machine,
wherein when the temperature of the food material accommodated in the housing is lower than the predetermined temperature, the food material accommodated in the housing is irradiated with microwaves while being stirred so as to be uniformly preheated, and the preheating is performed until the temperature is increased to a predetermined temperature of 25° C. or higher and 30° C. or lower within a predetermined preheating time of 10 minutes or less.
